(19) United States
(12) Patent Application Publication
(10) Pub. No.: US 2024/0148471 A1
(43) Pub. Date: May 9, 2024

(54) DENTAL DAM ASSEMBLY

(71) Applicant: Theodore Novak, Los Angeles, CA (US)

(72) Inventor: Theodore Novak, Los Angeles, CA (US)

(21) Appl. No.: 18/381,566

(22) Filed: Oct. 18, 2023

Related U.S. Application Data
(60) Provisional application No. 63/416,986, filed on Oct. 18, 2022.

(51) Int. Cl. A61C 5/82

(52) U.S. Cl. CPC A61C 5/82

(57) ABSTRACT

A dental dam assembly including a rubber dam, a frame, an elongate holding member, and a base mount. The rubber dam is held stretched flat by the frame in its proper arrangement within the patient's mouth, the elongate holding member is placed against the rubber dam adjacent the tooth receiving the dental treatment to hold the rubber dam tight in the area surrounding the tooth, and the base mount secures the frame and the holding member in place while enabling spatial adjustment thereof.

### FIELD OF THE INVENTION

This invention relates to dental devices, including dental dams.

### BACKGROUND

In general, a traditional dental dam is a square sheet of rubber (e.g., latex or nitrile) about six inches wide that is used to isolate one or more teeth during dental procedures. One or more small holes are punched through the sheet of rubber and the tooth receiving the dental treatment is pushed through the hole(s). A frame holds the rubber sheet generally flat and in the proper position within the patient's mouth. A metal tooth clamp is clamped around the tooth to anchor the rubber sheet around the tooth to generally seal and secure the rubber sheet in place. The purpose of the dental dam is to prevent saliva from interfering with the dental work, to prevent contamination of the operative site, to keep the materials dry, and to prevent injury to the patient's mouth.

The metal tooth clamp includes an open ring-shaped member with sharp concave side edges (e.g., jaws) that are expanded using forceps and then released about the outer sides of the tooth. The clamps typically comprise stainless steel, but other materials may be used.

However, because the clamps comprise sharp steel edges that must be expanded and placed over the tooth manually, there is a danger of the clamps slipping and cutting the rubber sheet, or worse yet, causing injury to the patient's mouth.

Accordingly, there is a need for a dental dam assembly that eliminates the need for tooth clamp component. The presently disclosed assembly addresses these needs.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a dental dam assembly according to exemplary embodiments hereof;

FIG. 2 shows an exploded view of a dental dam assembly according to exemplary embodiments hereof;

FIGS. 3A-3C show a holding member according to exemplary embodiments hereof; and

FIGS. 4A-4B show a base mount according to exemplary embodiments hereof.

### DETAILED DESCRIPTION OF EXEMPLARY EMBODIMENTS

In general, and according to exemplary embodiments hereof, a dental dam assembly is provided.

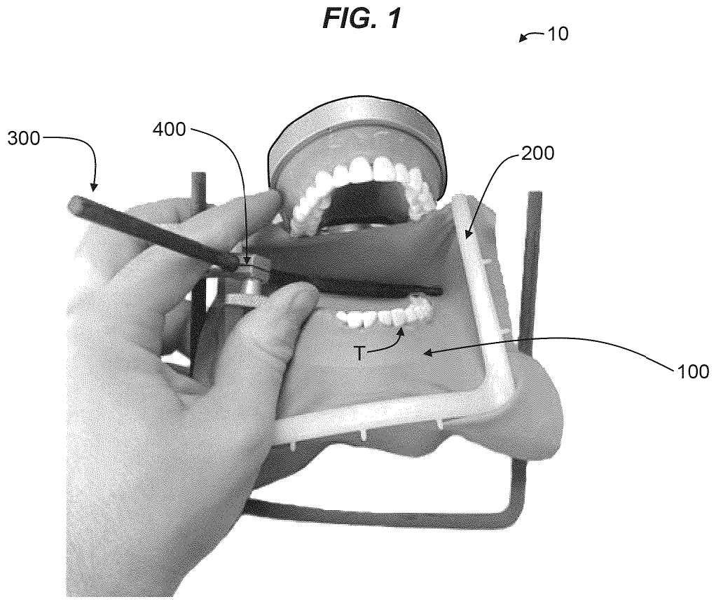

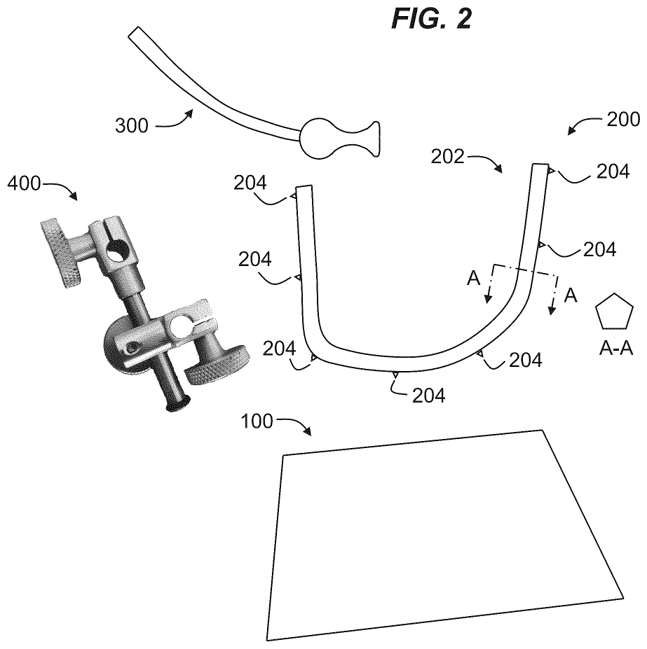

In some embodiments, as shown in FIGS. 1-2, the dental dam assembly 10 (also referred to herein as simply the system 10) includes a rubber dam 100, a frame 200, a holding member 300, and a base mount 400. FIG. 1 shows the assembly 10 implemented with a typodont teeth model, and FIG. 2 shows an exploded view of the assembly 10. In general, the rubber dam 100 is held stretched flat by the frame 200 in its proper arrangement within the patient's mouth, a portion of the holding member 300 is placed against the rubber dam 100 adjacent the tooth T receiving the dental treatment to hold the rubber dam 200 tight in the area surrounding the tooth T, and the base mount 400 secures the frame 100 and the holding member 300 in place while enabling three-dimensional spatial adjustment thereof. The dental dam assembly 10 also may include other elements and/or components as necessary to perform its functionalities.

As described above, traditional dental dam assemblies utilize a metal tooth clamp to anchor and seal the rubber dam around the tooth receiving the dental procedure. The metal tooth clamp includes sharp jaws that must be spread open manually and placed around the tooth, creating the potential of causing damage to the rubber dam, or worse yet, causing injury to the patient's mouth. With the dental dam assembly 10 of the current invention, the metal tooth clamp is essentially eliminated and replaced with the holding member 300.

In some embodiments, as shown in FIG. 2, the dental dam 100 includes a thin sheet of flexible rubber (e.g., latex or nitrile), typically cut square (e.g., 6″×6″). Being flexible, the dental dam 100 is configurable with the patient's mouth and teeth as shown in FIG. 1. Small holes may be punched through the dental dam 100 to receive each tooth that requires exposure for the dental procedure. Each tooth is pushed through an individual hole so that the dam 100 encircles each tooth individually thereby sealing the dam 100 around the teeth. Teeth that do not require exposure may be left beneath the dam 100.

In some embodiments, the dental dam 100 is held spread open and in its desired position within the patient's mouth by the frame 200. The frame generally includes a U-shaped member 202 (e.g., a U-shaped rod) with outwardly extending gripping members 204. The gripping members 204 may include small spikes, nubs, or other suitable gripping members 204. In some embodiments, the cross-sectional shape of the U-shaped member 202 is hexagonal as shown by the cut-lines A-A of FIG. 2. Other cross-sectional shapes such as circular, oval, square, rectangular, etc. also are contemplated.

In use, the dental dam 100 is engaged with the teeth T as described above, and then stretched across the frame 200 and pulled tight. The outer portions of the dam 100 are then engaged with the frame's gripping members 204 such that the dam 100 is held in its proper stretched position across the frame 200. The frame 200 then rests against the patient's cheeks and chin area.

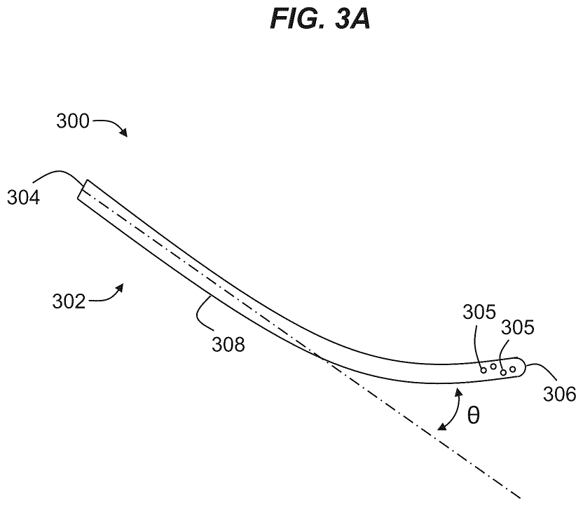

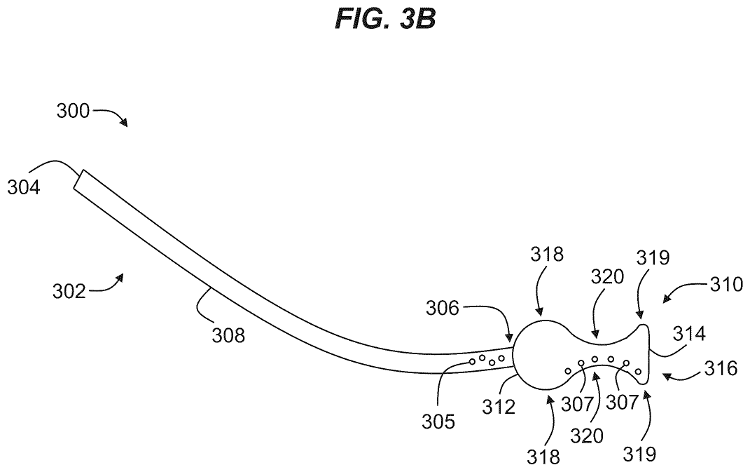

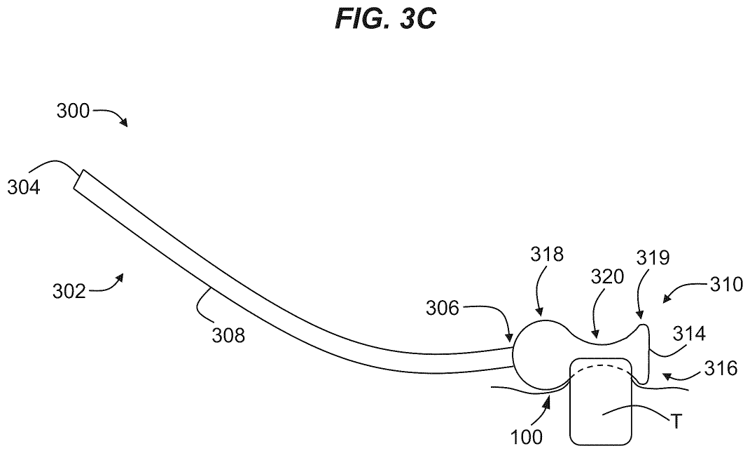

In some embodiments, as shown in FIG. 3A, the holding member 300 includes an elongate member 302 with a first end 304, a second end 306, and a member body 308 extending therebetween. The elongate member 302 may comprise a rod, a shaft, a pole, a beam, a wire, any other suitable type of elongate member, and any combinations thereof.

In some embodiments, as shown in FIG. 3A, the elongate member 302 includes a bend between its first end 304 and its second end 306. In some embodiments, the bend is located closer to the member's second end 306 compared to its first end 304. In some embodiments, the bend deflects the member 302 at an angle θ with respect to the member's longitudinal axis M. This angle enables the member 302 to be positioned within the patient's mouth as required during use. For example, as shown in FIG. 1, the elongate member 302 may be positioned to enter the patient's mouth at a generally direct angle into the mouth, and then to curve to a generally lateral (sideways or horizontal) position at its second end 306 to provide generally downward pressure to the rubber dam 100 at the point of contact. In this way, the holding member 300 helps to hold the dental dam in place during the dental procedure.

In some embodiments, the member 302 comprises a malleable material with sufficient memory, e.g., a rubber coated wire, such that the user may adjust the bend and the bend may hold its form during the dental procedure. That is, the forces involved with the dental procedure may preferably be less than the force necessary to reshape the bend. For example, the user may adjust the radius and location of the bend along the length of the member 302 depending on the age and/or size of the patient's jaw, which specific tooth is involved in the procedure, the type of procedure, etc. It is preferable that the member 302, once bent by the user, maintain its form during the dental procedure. In some embodiments, the member 302 may comprise a material, e.g., rubber, metal wire, rubber coated wire, plastic, etc., that may soften when heated such that the user may adjust the bend under heat. Then, the bend may harden when returned to room temperature for use in the procedure.

In other embodiments, the bend may be preset and may not be adjustable.

In some embodiments, the angle θ with respect to the member's longitudinal axis M is about 5°-85°, and preferably about 15°-75°, and more preferably about 25°-65°, and more preferably about 40°.

In some embodiments, the elongate member 302 includes one or more suctioning holes 305 in its distal end 306 with the suctioning holes 305 in fluid communication with a vacuum pump (or similar). For example, the member 302 may be hollow and its proximal end 304 may be attachable to a suctioning device (e.g., a pump via a hose) to provide suction through the member 302 and the holes 305. In this way, the member 202 may provide suctioning to clear saliva, blood, etc. from the area of the procedure while in use. This functionality may be in addition to the holding functionality of the member 302 as described in other sections.

In some embodiments, as shown in FIG. 3B, the holding member 300 includes an end member 310 configured with its second end 306. In some embodiments, the end member 310 includes a first end 312, a second end 314, and an end member body 316 extending therebetween. In some embodiments, the member's first end 312 includes an input port (e.g., a hole) into which the second end 306 of the elongate member 302 may be inserted and secured (e.g., via pressure fit, mating threads, using adhesive, etc.). In this way, the end member 316 may be removable and/or interchangeable with other end members 316 (e.g., of different sizes or shapes depending on the patient). In other embodiments, the end member 310 may be fixedly attached to the holding member's second end 306.

Being attached to the second end 306 of the elongate member 302, the end member 310 may provide a point of contact between the elongate member 302 and the rubber dam 100 and the patient's teeth T to hold the rubber dam 100 in place.

In some embodiments, as shown in FIG. 3B, the end member body 316 includes one or more convex curvatures 318 and/or one or more concave curvatures 320 on at least one of its outer surfaces that may be placed against the dental dam 100 and/or the patient's tooth T. For example, as shown in FIG. 3B, the member 316 may include a first convex curvature 318 followed by a first concave curvature 320 followed by a second convex curvature 319. The member 316 may include the curvatures 318, 320, 319 on a single side e.g., on its lower side, and/or on multiple sides, e.g., on the top and bottom sides as shown in FIG. 3B. It also is contemplated that the member body 316 include curvatures 318, 320, 319 on intermediate surfaces between its upper and lower surfaces (e.g., on its side surfaces).

The purpose of the convex curvatures 318 and/or concave curvatures 320 may be to provide form fitted surfaces at the point of contact between the end member 310 and the rubber dam 100 and the patient's teeth T. For example, in some embodiments, the elongate member 302 and the end member 310 may be positioned such that a concave curvature 320 of the end member 310 engages an upper surface of the point of contact within the patient's mouth (e.g., an upper surface of an exposed tooth T and/or an upper surface of a tooth underneath the dental dam 100 adjacent the tooth having the procedure) and the left and right side convex curvatures 318 engage the point of contact on either sides (e.g., on either side of an exposed tooth T and/or on either side of a tooth underneath the dental dam 100 adjacent the tooth having the procedure). In this way, the end member 310 may apply direct pressure to the point of contact to hold the dental dam 100 tight, sealed, and in the proper downward position for the dental procedure.

FIG. 3C shows the holding member's end member 310 engaged with an area of the dental dam 100 behind the tooth T to hold the dental dam 100 in place in this area.

In some embodiments, the curvatures 318, 320, 319 on one side of the end member body 316 may mirror the curvatures 318, 320, 319 on another side of the member body 316 (as shown in FIG. 3B). In other embodiments, the curvatures 318, 320, 319 on one side may be different than the 318, 320, 319 on another side such that the end member body 316 may be rotated about the end 306 of the elongate member 302 to place a different set of curvatures 318, 320, 319 in position for use (e.g., facing downwards). It also is contemplated that the form of the curvatures 318, 320, 319 continuously vary about the outer circumference of the member body 316 so that as the member body 316 is rotated, a different set of curvatures 318, 320, 319 may be properly positioned and utilized. In some embodiments, the form of the curvatures 318, 320, 319 facing downward for use may vary from smaller to larger as the end member 302 is rotated. In this way, the user may place the holding member 302 and end member 310 into the patient's mouth and then rotate the end member 310 until a particular set of curvatures 318, 320, 319 are in a downward facing position and a proper fit is achieved.

In some embodiments, the first convex curvature 318 may include a larger radius than the second convex curvature 319, while in other embodiments, the curvature radiuses may generally match (depending on the size and shape of the patient's jaw and teeth). In some embodiments, the second convex curvature 319 may include a smaller radius compared to the first convex curvature 318 such that the member body 316 does not push too far outward into the patient's cheek area when in place.

In some embodiments, a first end member 310 having a particular size and shape may be replaceable with a second end member 310 having a different size and shape. For example, an end member 310 for use with an adult may be larger (e.g., longer from its first side 312 to its second side 314) than an end member 310 for use with a child.

It also is contemplated that the end member body 316 have different shapes, forms, and/or sizes depending on the particular tooth involved with the procedure, the type of procedure, etc. For example, the end member body 316 (and/or the distal end 306 of the elongate member 302) may diverge into two separate portions (e.g., like a sideways “U”) such that a first portion may be placed adjacent the tooth T on one side of the tooth T and a second portion may be placed adjacent to the tooth T on an opposite side of the tooth T (e.g., behind and in front of the tooth T). In another example, the end member body 316 and/or the distal end 306 of the elongate member 302 may include an “O” shape e.g., a donut shaped body with an opening in the middle for access to the tooth T. In this way, the end member body 316 and/or the distal end 306 of the elongate member 302 may press downward on the dental dam 100 about the entire perimeter of the tooth T. It is understood that the end member 310 may include any form or shape, with any types and numbers of curvatures as necessary to provide a form fitted point of contact between the holding member 300 and the point of contact with the dental dam 100 within the patient's mouth.

Given the above, it may be preferable that the end member 310 comprise a compressible material such as rubber or foam, however, it is understood that any suitable material, and/or any combinations of suitable materials thereof may be used.

In some embodiments, the suction holes 305 on the distal end 306 of the elongate member 302 may be exposed when the end member 310 is configured with the member's distal end 306 such that the elongate member 302 may be used as a suction device even with the end member 310 attached thereto. In some embodiments, the end member 310 itself may include suction holes 307 that may be placed in fluid communication with the elongate member's suction holes 305 (and/or with the elongate member's hollow internal passageway and/or with the pump directly) such that the end member 310 may be used as a suction device during the procedure.

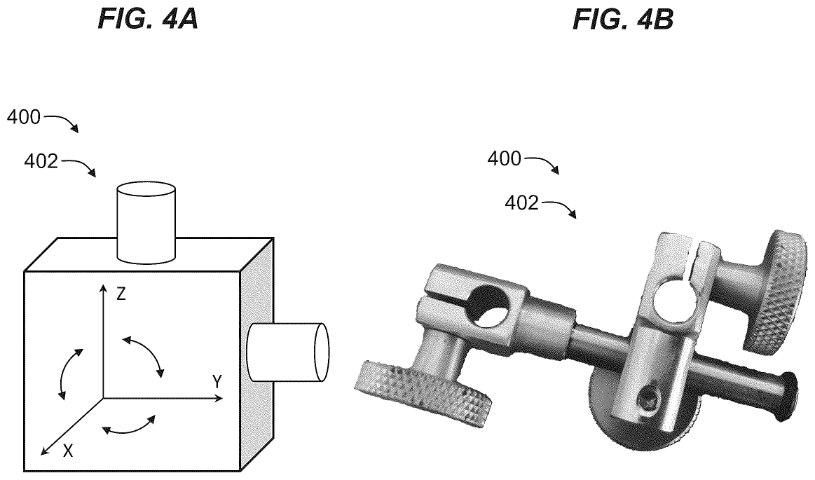

In some embodiments, as shown in FIG. 4A, the base mount 400 includes a multi-axis adjustable mount 402 configurable to hold, secure, position, and/or lock the frame 200 and the holding member 300 individually and independently and with respect to one another along any spatial axis (e.g., X-, Y-, and Z-axis) and at any angle. The mount 402 is preferably able to be adjusted (manually and/or automatically) to position each element 200, 300, and the angle of each element 200, 300 with respect to one another and with respect to the patient (e.g., the patient's tooth T) during use, and to lock the elements 200, 300 in place once set. In this way, the base mount 400 may be configured to hold, position, and lock the frame 200 (and the attached dental dam 100) and the holding member 300 in any position and at any angle during the dental procedure as required (see, e.g., FIG. 1).

In some embodiments, as shown in FIG. 4B, the adjustable mount 402 includes an X-, Y-, Z-axis alignment mount, however, it is understood that any type of suitable mount 402 may be utilized. While a single mount 402 is shown, it is understood that multiple mounts 402 may be combined in any way to provide the necessary functionalities. It also is understood that any type of mount(s) may be used, and that the scope of the assembly 10 is not limited in any way by the type of mount(s) utilized. It also is understood that while the alignment mount in FIG. 4B is depicted as using thumb screws to tighten and/or lock the settings, other mechanisms, such as quick release cam levers, also may be used.

It is understood that any aspect and/or element of any embodiment of the assembly 10 described herein or otherwise may be combined in any way with any other aspect and/or element of any other embodiment to form additional embodiments of the assembly 10 all of which are within the scope of the assembly 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A dental dam assembly comprising:
a dental dam frame;
a dental dam configured with the dental dam frame;
an elongate holding member with a first end and a second end; and
a base mount configured with the dental dam frame and with the elongate holding member;
wherein the second end of the elongate holding member is adapted to be placed in contact with the dental dam to hold the dental dam in place;
wherein the base mount is adapted to lock the position of the dental dam frame and of the elongate holding member with respect to one another.

2. The dental dam assembly of claim 1 further comprising;
an end member coupled to the second end of the elongate holding member and including at least one concave surface adapted to be placed into contact with the dental dam to hold the dental dam in place.

3. The dental dam assembly of claim 2 wherein the end member comprises a compressible material.

4. The dental dam assembly of claim 1 wherein the base mount includes an X-, Y-, Z-axis alignment mount.

5. The dental dam assembly of claim 1 wherein the elongate holding member includes a longitudinal axis and a bend between its first end and its second end of about 25° to 60° with respect to the longitudinal axis.

6. The dental dam assembly of claim 5 wherein the elongate holding member includes a longitudinal axis and a bend between its first end and its second end of about 40° with respect to the longitudinal axis.

7. The dental dam assembly of claim 1 wherein the second end of the elongate holding member includes one or more suction holes in fluid communication with a vacuum pump to provide suction.

8. The dental dam assembly of claim 2 wherein the at least one concave surface of the end member includes one or more suction holes in fluid communication with a vacuum pump to provide suction.
